(19) United States
(12) Patent Application Publication
(10) Pub. No.: US 2013/0181660 A1
(43) Pub. Date: Jul. 18, 2013

(54) CHARGE CONTROL CIRCUIT FOR USB DEVICE

(71) Applicant: HAI-QING ZHOU, Shenzhen City (CN)

(72) Inventor: HAI-QING ZHOU, Shenzhen City (CN)

(21) Appl. No.: 13/663,504

(22) Filed: Oct. 30, 2012

(30) Foreign Application Priority Data
Jan. 12, 2012 (CN) 201210007984.7

(51) Int. Cl. H02J 7/00

(52) U.S. Cl. 320/107

(57) ABSTRACT

A charge control circuit used in a computer includes a backup power supply, a USB connector electronically connected to a USB device, a charge control unit powered by the backup power supply, a switch unit, and a southbridge chip. The charge control unit includes a charge controller. The switch unit includes an electronic switch electronically connected to the charge controller and the backup power supply. The southbridge chip includes a USB controller, the southbridge chip selectively controls the charge controller or the USB controller to transmit enumeration signals to the USB connector to recognize and activate the USB device to be charged according to a working mode of the computer, and switches the electronic switch to connect or disconnect the power supply to the USB connector according to the working mode of the computer.

### BACKGROUND

1. Technical Field

The exemplary disclosure generally relates to charge control circuits, particularly to a charge control circuit for universal serial bus (USB) devices.

2. Description of Related Art

USB devices, such as mobile phones, tablet computers, or MP3 players for example, are electronically connected to a computer via a USB cable to communicate with and be charged or recharged by the computer. The computer includes a USB controller and a USB connector. When a USB device is connected to the USB connector, the USB controller transmits enumeration signals to the USB device, and receives signals in response transmitted from the USB device, to recognize the USB device. The USB device can communicate with and be charged by the computer only when the USB device is successfully enumerated by the computer. In other words, a charge circuit of the USB device can be activated only when the USB device receives enumeration signals.

However, when the computer is in a sleep or standby mode, the USB controller stops working, such that the USB device connected to the USB connector cannot receive the enumeration signals from the USB controller, and thus cannot be charged.

Therefore, there is room for improvement within the art.

### BRIEF DESCRIPTION OF THE DRAWINGS

Many aspects of the embodiments can be better understood with reference to the drawings. The components in the drawings are not necessarily drawn to scale, the emphasis instead being placed upon clearly illustrating the principles of the disclosure.

FIG. 1 shows a block diagram of an exemplary embodiment of a charge control circuit.

FIG. 2 shows a schematic circuit diagram of the charge control circuit shown in FIG. 1.

### DETAILED DESCRIPTION

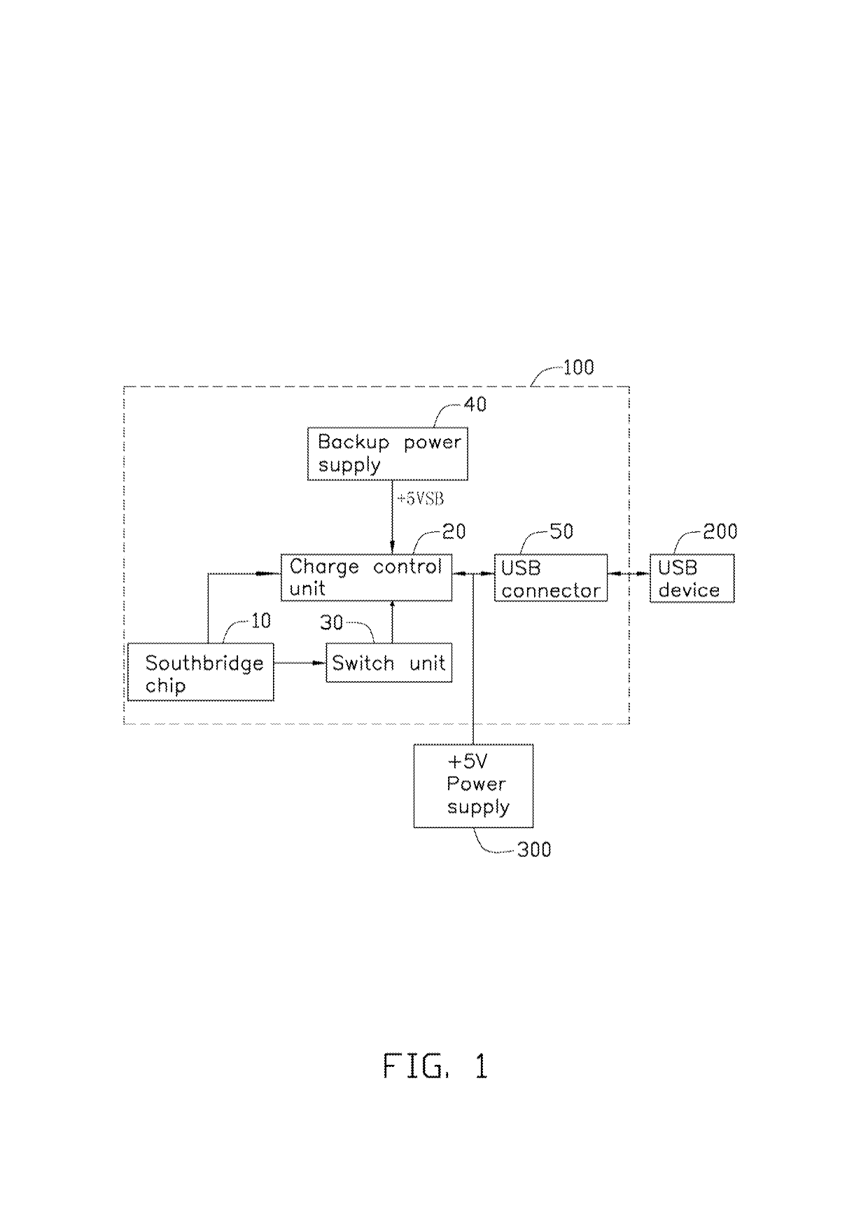

FIG. 1 shows a block diagram of an exemplary embodiment of a charge control circuit 100. The charge control circuit 100 can be used in a computer to control the electrical charging or recharging of a USB device 200, such as a mobile phone or tablet computer for example, that is connected to the computer. The charge control circuit 100 includes a southbridge chip 10, a charge control unit 20, a switch unit 30, a backup power supply 40, and a USB connector 50. The USB connector 50 electronically connects the USB device 200 to the charge control circuit 100. When the computer is in a sleep or standby mode, the southbridge chip 10 controls the charge control unit 20 to transmit enumeration signals to the USB device 200. Meanwhile, the southbridge chip 10 controls the switch unit 30 to electronically connect the backup power supply 40 to the USB device 200, to electrically charge the USB device 200. In one embodiment, the backup power supply 40 outputs a 5V voltage labeled as +5 VSB.

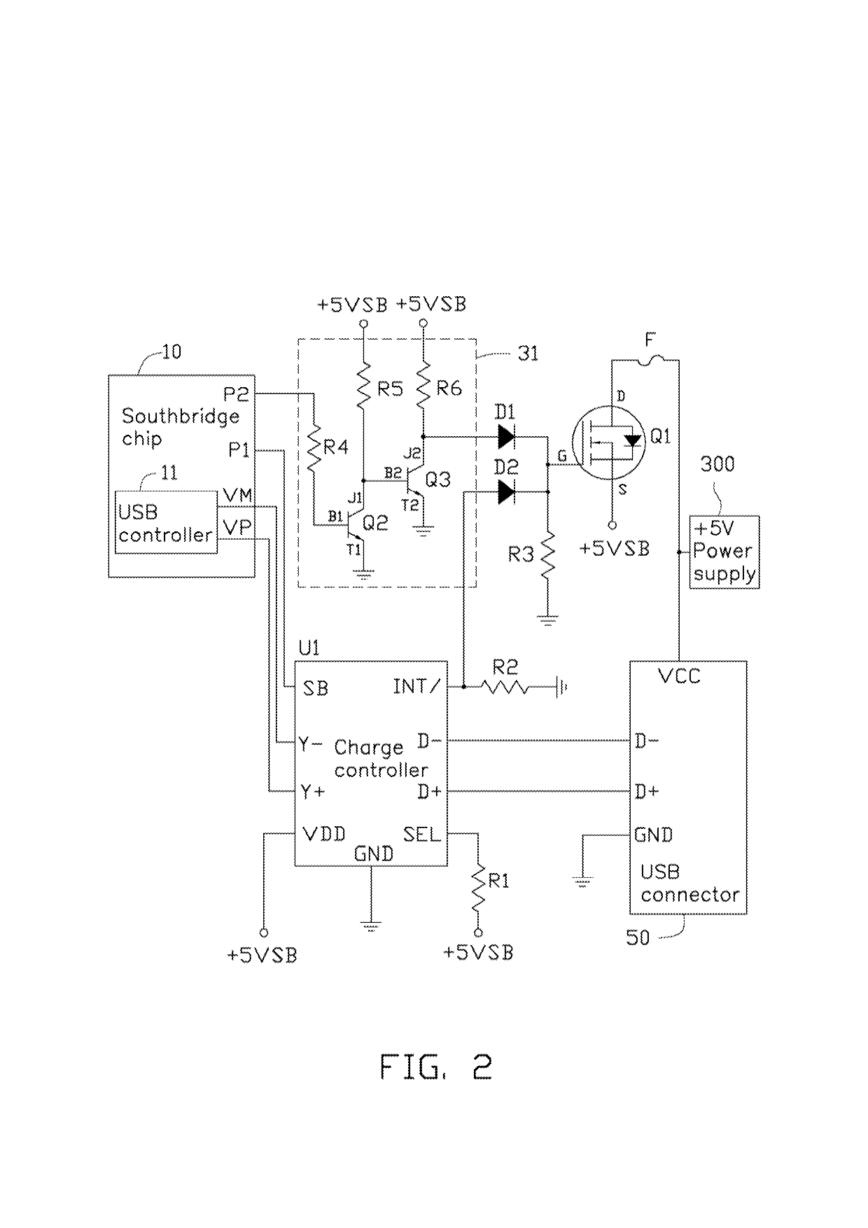

FIG. 2 shows a schematic circuit diagram of the charge control circuit 100 shown in FIG. 1. The southbridge chip 10 includes a first control pin P1, a second control pin P2, a positive differential pin VP and a negative differential pin VM. A USB controller 11 is integrated in the southbridge chip 10, and is electronically connected to the positive differential pin VP and negative differential pin VM.

The charge control unit 20 includes a charge controller U1, a first pull-up resistor R1 and a first pull-down resistor R2. The charge controller U1 includes a power pin VDD, a ground pin GND, two positive differential pins Y+ and D+, two negative differential pins Y− and D−, a first input pin SB, a second input pin SEL, and an output pin INT/. The power pin VDD is electronically connected to the backup power supply 40, to obtain +5 VSB. The ground pin GND is grounded. The positive and negative differential pins Y+ and Y− are electronically and respectively connected to the positive and negative differential pins VP and VM of the USB controller 11. The positive and negative differential pins D+ and D− are electronically connected to the positive and negative differential pins D+ and D− of the USB connector 50, respectively. The first input pin SB is electronically connected to the first control pin P1 of the southbridge chip 10. The second input pin SEL is electronically connected to the backup power supply 40 via the first pull-up resistor R1. The output pin INT/ is grounded via the first pull-down resistor R2. When the first input pin SB observes a logic change (from high (logic 1) to low (logic 0) or from low to high), the output pin INT/ is high for a predetermined time (such as 1.8 seconds, for example), otherwise the output pin INT/ is high impedance (hi-z).

When the computer is in a normal mode, the charge controller U1 connects the USB controller 11 to the USB connector 50, the USB controller 11 transmits enumeration signals to the USB device 200 via the charge controller U1 and the USB connector 50. When the computer is in a sleep or standby mode, the charge controller 11 generates and transmits the enumeration signals to the USB device 200.

In detail, when the computer is in a normal mode, the first control pin P1 of the southbridge chip 10 outputs a high level signal to the first input pin SB of the charge controller U1, to control the charge controller U1 to connect the positive and negative differential pins D+ and D− of the USB connector 50 to the positive and negative differential pins VP and VM. At this time, the USB controller 11 outputs enumeration signals to the USB device 200 via the charge controller U1, to invite a recognizable response from the USB device 200 and to activate the USB device 200 to charge.

When the computer works is in a sleep or standby mode, the USB controller 11 stops working. The southbridge chip 10 outputs a low level voltage signal to the first input pin SB of the charge controller U1 via the first control pin P1. The charge controller U1 outputs enumeration signals to the USB device 200 via the positive and negative differential pins D+ and D−, to activate the USB device 200 to charge.

In one embodiment, the charge controller U1 can be a PI5USB1457 type charge controller, made for example by PERICOM.

The switch unit 30 includes a level shift unit 31, a first diode D1, a second diode D2, an electronic switch Q1, a second pull-down resistor R3 and a fuse F. In one embodiment, voltage of the high level voltage signal output from the southbridge chip 10 is 3.3 volts, and the level shift unit 31 transforms the high level voltage at a first amplitude (e.g. 3.3 volts) output from the southbridge chip 10 to a high level voltage at second amplitude (e.g. 5 volts), to switch off the electronic switch Q1. The level shift unit 31 includes a first NPN type bipolar junction transistor (BJT) Q2, a second NPN type BJT Q3, a current limiting resistor R4, a second pull-up resistor R5, and a third pull-up resistor R6. A base B1 of the first NPN type BJT Q2 is electronically connected to the second control pin P2 of the southbridge chip 10 via the current limiting resistor R4; an emitter T1 of the first NPN type BJT Q2 is grounded; and a connector J1 of the first NPN type BJT Q2 is electronically connected to the backup power supply 40 via the second pull-up resistor R5. A base B2 of the second NPN type BJT Q3 is electronically connected to a node between the second pull-up resistor R5 and the connector J1 of the first NPN type BJT Q2; an emitter T2 of the second NPN type BJT Q3 is grounded; and a connector J2 of the second NPN type BJT Q3 is electronically connected to the backup power supply 40 via the third pull-up resistor R6. An anode of the first diode D1 is electronically connected to a node between the third pull-up resistor R6 and the connector J2 of the second NPN type BJT Q3, and a cathode of the first diode D1 is electronically connected to the electronic switch Q1. An anode of the second diode D2 is electronically connected to a node between the output pin INT/ and the first pull-down resistor R2, and a cathode of the second diode D2 is electronically connected to the electronic switch Q1.

In the exemplary embodiment, the electronic switch Q1 is a P-channel metal-oxide-semiconductor field-effect transistor (MOSFET). A gate G of the P-channel MOSFET is electronically connected to the cathodes of both the first diode D1 and the second diode D2, a source S of the P-channel MOSFET is electronically connected to the backup power supply 40, and a drain of the P-channel MOSFET is electronically connected to a power pin VCC of the USB connector 50 via the fuse F. The drain of the P-channel MOSFET is further grounded via the second pull-down resistor R3. The fuse F protects the USB device 200 connected to the USB connector 50 from a current surge or overcurrent.

When the computer is in a normal mode, the computer supplies a normal power supply, such as a +5V, through the power supply 300 to the power pin VCC of the USB connector 50, to charge the USB device 200. Meanwhile, the second control pin P2 of the southbridge chip 10 outputs a high level voltage signal at 3.3 volts to the first NPN type BJT Q2. At this time, the first NPN type BJT Q2 is switched on, the second PNP type BJT Q3 is switched off, and the first diode D1 is switched on. The voltage of the gate G of the P-channel MOSFET Q1 is at a high level (+5V), switching off the P-channel MOSFET Q1, and thereby disconnecting the backup power supply +5 VSB from the power pin VCC of the USB connector 50.

When the computer switches to a sleep or standby mode, the second control pin P2 of the southbridge chip 10 stops outputting a high level voltage, and the second control pin P2 is thus at high impedance, the first NPN type BJT Q2 is switched off, the second NPN type BJT Q3 is switched on, and the first diode D1 is switched off. Meanwhile, the first control pin P1 outputs a low level voltage signal to the first input pin SB of the charge controller U1, the controller U1 outputs enumeration signals to the USB device 200, to activate the USB device 200 to charge. Since the first input pin SB detects a logic change (from high to low), the output pin INT/ is high for 1.8 seconds. When the output pin INT/ is high, the second diode D2 is switched on, the gate G of the P-channel MOSFET Q1 is also high, and the P-channel MOSFET Q1 is switched off for 1.8 seconds, to allow a time of 1.8 seconds to the USB device 200 for receiving and responding to the enumeration signals and preparing for charging. After that, the output pin INT/ returns to high impedance, and the second diode D2 is switched off. Since the first diode D1 is also switched off at this time, the gate G of the P-channel MOSFET Q1 is therefore low, to switch on the P-channel MOSFET Q1 and thereby connecting the backup power supply 40 to the power pin VCC of the USB connector, thereby allowing charging of the USB device 200.

The electronic switch 30 can be a PNP type BJT, of which the base, the emitter, and the collector have electronic connections corresponding to those of the gate G, source S and the drain D of the P-channel MOSFET.

The exemplary embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A charge control circuit used in a computer, comprising:
a backup power supply;
a USB connector electronically connected to a universal serial bus (USB) device;
a charge control unit powered by the backup power supply and comprising a charge controller;
a switch unit comprising an electronic switch electronically connected to the charge controller and the backup power supply; and
a southbridge chip comprising a USB controller, the southbridge chip selectively controlling the charge controller or the USB controller to transmit enumeration signals to the USB connector to recognize and activate the USB device to be charged according to a working mode of the computer, and switching the electronic switch to connect or disconnect the power supply to the USB connector according to the working mode of the computer.

2. The charge control circuit of claim 1, wherein the southbridge chip comprises a first control pin, the switch unit further comprises a first diode, and a level shift unit electronically connected to the first control pin of the southbridge chip, an anode of the first diode is electronically connected to the output terminal of the level shift unit, and an cathode of the first diode is electronically connected to the electronic switch, the level shift unit transforms a high level voltage at a first amplitude output from the southbridge chip to a high level voltage at a second amplitude, the high level voltage at the second amplitude is output to the electronic switch via the first diode to switch off the electronic switch.

3. The charge control circuit of claim 2, where in the level shift unit comprises a first NPN type bipolar junction transistor (BJT), a second NPN type BJT, and a current limiting resistor, a base of the first NPN type BJT is electronically connected to a control pin of the southbridge chip via the current limiting resistor; an emitter of the first NPN type BJT is grounded; and a connector of the first NPN type BJT is electronically connected to the backup power supply; a base of the second NPN type BJT is electronically connected to the connector of the first NPN type BJT; an emitter of the second NPN type BJT is grounded; and a connector of the second NPN type BJT is electronically connected to the backup power supply; the anode of the first diode is electronically connected to a node between the collector of the second NPN type BJT and the backup power supply.

4. The charge control circuit of claim 2, wherein the electronic switch is a P-channel metal-oxide-semiconductor field-effect transistor (MOSFET), the switch unit further comprises a pull-down resistor, a gate of the P-channel MOSFET is electronically connected to the cathodes of the first diode, a source of the P-channel MOSFET is electronically connected to the backup power supply, and a drain of the P-channel MOSFET is electronically connected to a power pin of the USB connector, the drain of the P-channel MOSFET is further grounded via the pull-down resistor.

5. The charge control circuit of claim 4, wherein the charge controller comprises a first input pin and two pairs of differential pins, the USB controller comprises a pair of differential pins correspondingly connected to one pair of differential pins of the charge controller, the other pair of differential pins of the charge controller are correspondingly connected to differential pins of the USB connector, the southbridge chip further comprises a first control pin electronically connected to the first input pin of the charge controller.

6. The charge control circuit of claim 5, wherein when the computer is in a normal mode, the southbridge chip outputs a high level voltage signal to the first input pin of the charge controller via the first control pin, the charge controller connects the USB controller to the USB connector, the USB controller transmits enumeration signals to the USB device via the charge controller and the USB connector; when the computer is in a sleep or standby mode, the southbridge chip outputs a low level signal to the first input pin of the charge controller via the first control pin, the charge controller generates and transmits enumeration signals to the USB device.

7. The charge control circuit of claim 6, wherein when the computer is in a sleep or standby mode, the first control pin is at high impedance.

8. The charge control circuit of claim 7, wherein the charge controller further comprises an output pin, when the first input pin observes a logic change, the output pin INT/ is high for a predetermined time, otherwise the output pin INT/ is high impedance.

9. The charge control circuit of claim 2, where the electronic switch is a PNP type BJT, the switch unit further comprises a pull-down resistor, a base of the P-channel MOSFET is electronically connected to the cathodes of the first diode, an emitter of the P-channel MOSFET is electronically connected to the backup power supply, an a collector of the P-channel MOSFET is electronically connected to a power pin of the USB connector, the drain of the P-channel MOSFET is further grounded via the pull-down resistor.

10. The charge control circuit of claim 1, wherein the charge control unit further comprises a fuse electronically connected between the electronic switch and a power pin of the USB controller.
